(19) United States
(12) Patent Application Publication
(10) Pub. No.: US 2008/0181738 A1
(43) Pub. Date: Jul. 31, 2008

(54) Stall saw improvement

(76) Inventors: William Capriotti, Newtown Square, PA (US); Frank Linker, Broomall, PA (US); Frank Linker, Springfield, PA (US)

Correspondence Address: Eugene E. Renz, Jr., P.C., 205 North Monroe Street, Post Office Box 2056, Media, PA, 19063-9056, US

(21) Appl. No.: 12/006,948

(22) Filed: Jan. 8, 2008

Related U.S. Application Data
(60) Provisional application No. 60/878,820, filed on Jan. 8, 2007.

(51) Int. Cl. B26D 11/00; B23B 51/00

(52) U.S. Cl. 408/207; 83/863

(57) ABSTRACT

A tool for forming a tapered seat in wood subflooring for a drain fixture having a predetermined thickness comprising an inverted cup shaped cutting saw having a top and a depending circular skirt having saw teeth formed on the lower terminal edge of the skirt, and an adaptor mounted on the top of said stall saw, at least one cutting blade mounted on said adaptor having a cutting edge disposed angularly to relating to the axis of rotation of said saw and detent means limiting the cutting depth of the tool to form the tapered seat in the subflooring.

### BACKGROUND OF THE INVENTION

The present invention relates to improvements in so called stall saws used to form a beveled opening in the sub flooring for a drainage pipe in bathroom showers. This stall saw is cup shaped having a circular disc-like top and a generally tubular skirt depending from and formed integrally with the outer peripheral edge of the top which has cutting teeth on the lower peripheral edge of the skirt. The saw has a drill bit depending from the center of the top aiding a user in locating the center of the seat to be formed in a precise location in the subflooring. The drill also acts as a stabilizer during the cutting cycle.

Presently the user simply mounts the cutting blade assembly in a chuck of a power drill, places the drill bit in the spot designated and activates the drill to form a circular straight sided hole in the subflooring. The user withdraws the cutting blade and plug, presses the plug out of the saw to discard the disc cut from the subflooring. The user then shapes the opening with another tool such as a coping saw or router to provide a beveled seat for the drain assembly.

It has been found that this method is time consuming and even skilled mechanics have difficulty beveling the opening to provide a firm, uniform leak free seat for the drain assembly.

### SUMMARY OF THE INVENTION

The present invention provides an improved cutting tool which in a single pass forms the circular opening and a precise bevel in one pass of the tool. The operation is quick and precise even in the hands of a worker having marginal skills.

FIGS. 1-17 show a first embodiment of the invention comprising an adaptor for a stall saw of inverted cup-like shape suitably secured to the top of the stall saw having three depending circumferentially equispaced ears around the periphery of the stall saw side wall. Each ear as shown mounts a tapered cutting blade and a radially outwardly directed pin positioned to engage the top surface of the sub flooring when the circular cutting blade has cut through the subflooring and the lower cutting edge of the tapered blades are just short of penetrating the top face of the subflooring. By this arrangement, the drag on each stage of the cutting operation is minimal and the power demands are optimum. (See FIG. 17a).

There is shown in FIGS. 19-25 another embodiment of stall saw in accordance with the present invention. In this embodiment, the circular hole cutting blades and tapered blades are combined in a unitary tool.

### BRIEF DESCRIPTION OF THE FIGURES

FIG. 1 is a perspective view of a conventional stall saw for cutting a circular hole in a subfloor;

FIG. 2 is a top plan view of the cutting tool and subfloor;

FIG. 3 is an enlarged sectional view taken on lines A-A of FIG. 2;

FIG. 4 is a perspective view of a typical drain assembly for mounting in the tapered hole in the subfloor;

FIG. 5 is a top view of the drain assembly and subfloor;

FIG. 6 is an enlarged transverse sectional view taken along lines B-B of FIG. 5;

FIG. 7 is a perspective view showing the finished drain assembly and floor of a shower or the like;

FIG. 8 is a top plan view of the completed installation of FIG. 7;

FIG. 9 is an enlarged sectional view of taken on lines C-C of FIG. 8 showing the finished flooring and compartments of the drain assembly including the flush seating of the tapered circumferentially extending flange of the drain housing seated flush on the tapered seat in the subflooring;

FIG. 10 is an enlarged sectional view of the portion circled in FIG. 9 showing details of the seal and drain assembly;

FIG. 11 is a perspective view of a first embodiment of the invention comprising an adaptor for mounting on a conventional stall saw of the type described above to facilitate forming a beveled circular opening in a sub floor for a drain assembly;

FIG. 12 is a perspective view of the adaptor-saw assembly shown in FIG. 11 as viewed from the bottom side;

FIG. 13 is a perspective view of the adaptor as seen from the bottom side;

FIG. 14 is an exploded perspective view of the elements comprising the combined adaptor stall saw for cutting a tapered opening in a sub floor in a single operation;

FIG. 15 is a perspective view of the adaptor embodiment showing a section of flooring with a tapered hole for mounting a drain assembly;

FIG. 15a is a perspective view of the adaptor version;

FIG. 16 is a top plan view of the adaptor;

FIG. 16a is a plan view of the adaptor version of the subfloor;

FIG. 17 is an enlarged sectional view taken on lines D-D of FIG. 16 showing the means for securing the adaptor to the stall saw and the beveled cutting blades for forming the outwardly tapered hole and the locating pins for precision cutting each tapered hole to accommodate the tapered flange of the drain assembly housing;

FIG. 17a is a sectional view taken on lines E-E of FIG. 16a;

FIG. 18 shows another embodiment of stall saw assembly in accordance with the present invention for cutting a tapered opening for a strainer assembly in one operation;

FIG. 19 is a top plan view thereof;

FIG. 20 is a side elevational view thereof;

FIG. 21 is an enlarged view of the assembly and the parts thereof shown in the circled area in FIG. 20;

FIG. 22 is a transverse sectional view take on lines F-F of FIG. 20;

FIG. 23 is a perspective view of the second embodiment;

FIG. 24 is a top plan view thereof; and

FIG. 25 is an enlarged transverse sectional view take on lines G-G of FIG. 24.

### DESCRIPTION OF THE PREFERRED EMBODIMENTS

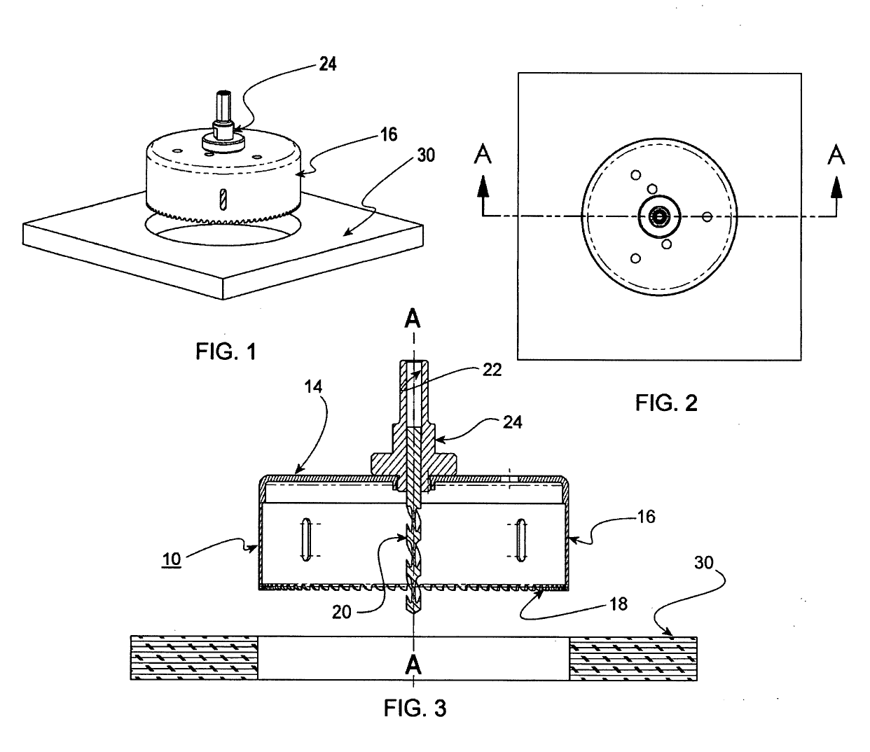

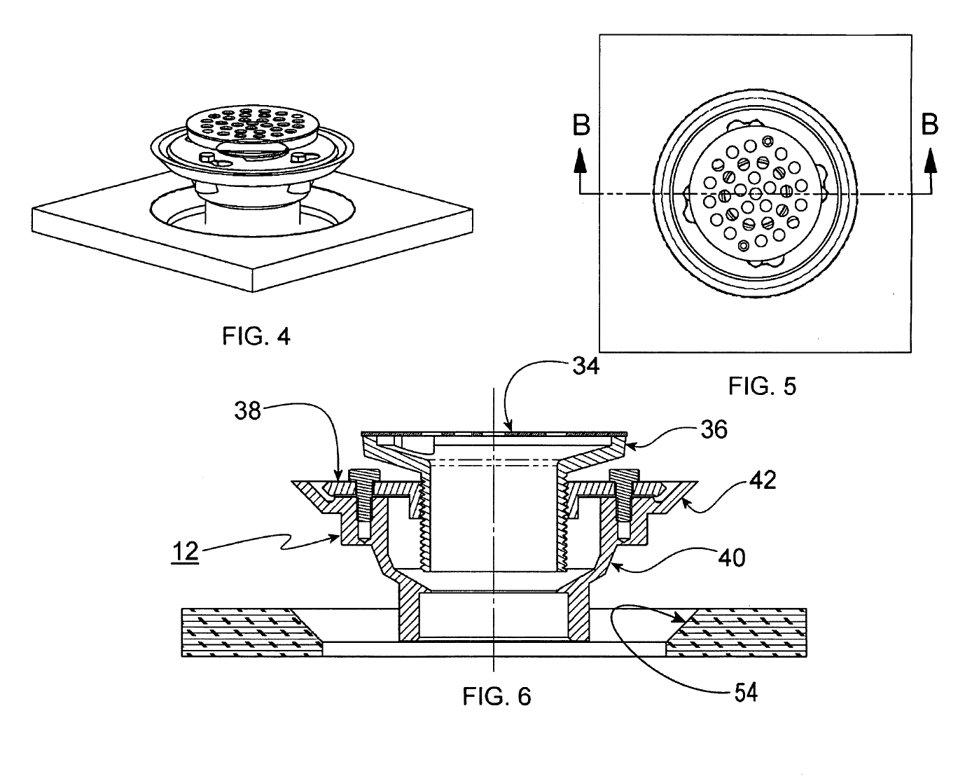

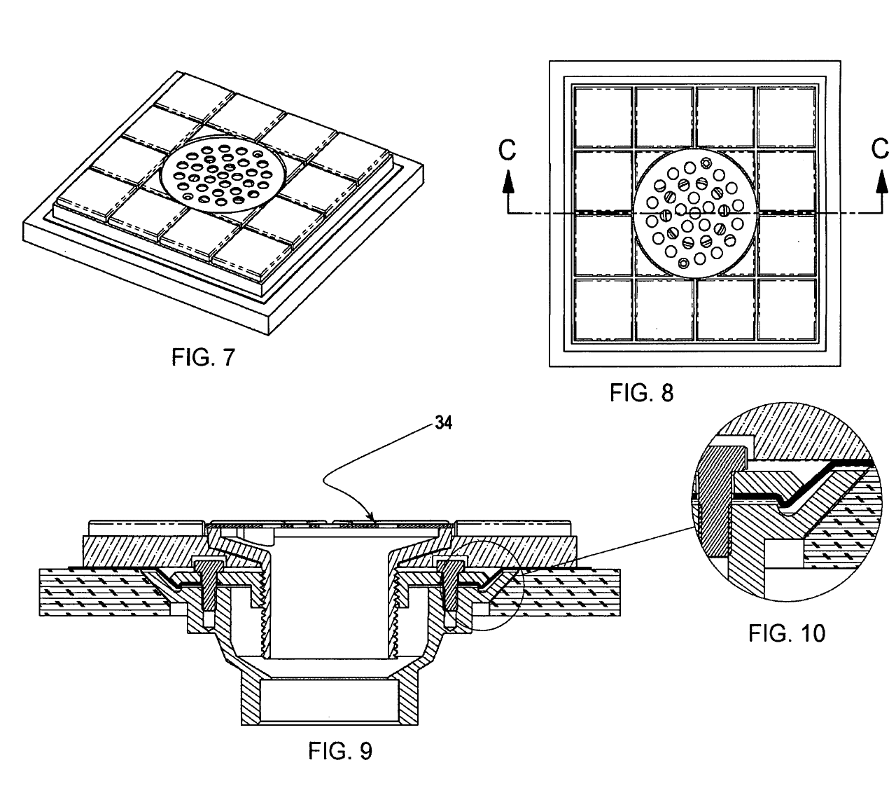

A prior art stall saw (10) for use in mounting a drain assembly (12) in the sub flooring of a stall shower or the like is shown in FIGS. 1-10 inclusive. The saw (10) is generally cup shaped having a generally circular disc like top (14) and a circumferentially extending skirt (16) depending from the outer peripheral edge of the top having a series of cutting saw teeth (18) formed on the lower edge of the skirt. A centering pilot drill (20) is mounted in the bore of a chuck (24) which in turn is removably mounted centrally in the top of the saw. The chuck (24) has an elongated shank (26) of polygonal shape to fit a drill bit of a standard portable drill. The top has several knockout holes (28) to assist in removing the disc like plug created from the cut in the subfloor (30).

The present invention is an improvement in stall saws which are typically used to form a seat for a conventional drain assembly (12) comprising a circular perforated drain plate (34) which sits on the open upper end of a drain plate mount (36) which in turn threads into a cap (38) secured by bolts to a housing (40) having a downwardly and inwardly tapered circumferentially extending wall (42) which seats on a tapered seat (44a) in the subflooring (30).

Considering briefly use of the stall saw described above, the centering drill (20) is adjusted in the bore of the chuck (24) so that the drill tip projects slightly below a transverse plane through the tip of the saw teeth (18) and locked at this setting. The shank is then locked in the drill bit of a portable drill. The stall saw is now ready to use. Simply activate the saw and position the tip of centering drill (20) at the center of target area in the sub floor. Advance drill to cut a straight sided circular plug (FIG. 3). Withdraw saw (10) and remove plug. The circular opening must now be shaped to bevel the hole formed in the subfloor to accommodate the tapered peripheral wall (42) of the drain housing (40) (FIG. 6). Presently this is done by use of a router tool or saber saw. It has been found that this process or procedure is very time consuming and often time the seat formed is cockeyed to a degree that the drain plate is not flush or even with the finished tile floor of the shower. This detracts from the architectural appearance and in some cases produces undesirable leakage paths.

The present invention provides an improved tool characterized by novel features of construction and arrangement capable of forming the tapered seat for drain assemblies in a single operation and wherein the seal formed is truly concentric and does not depend on the skill of the tool operator.

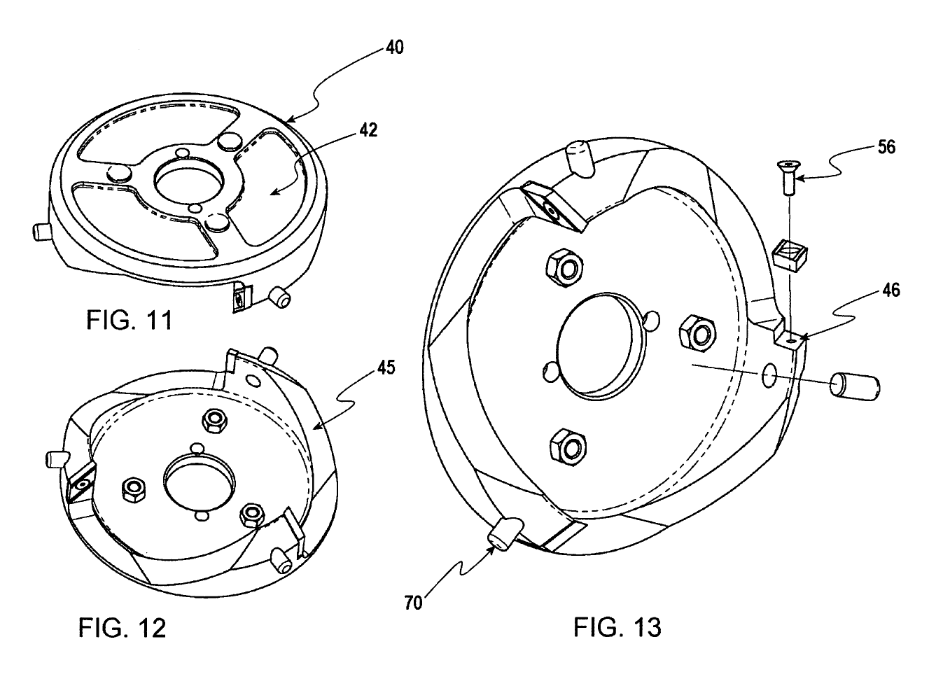

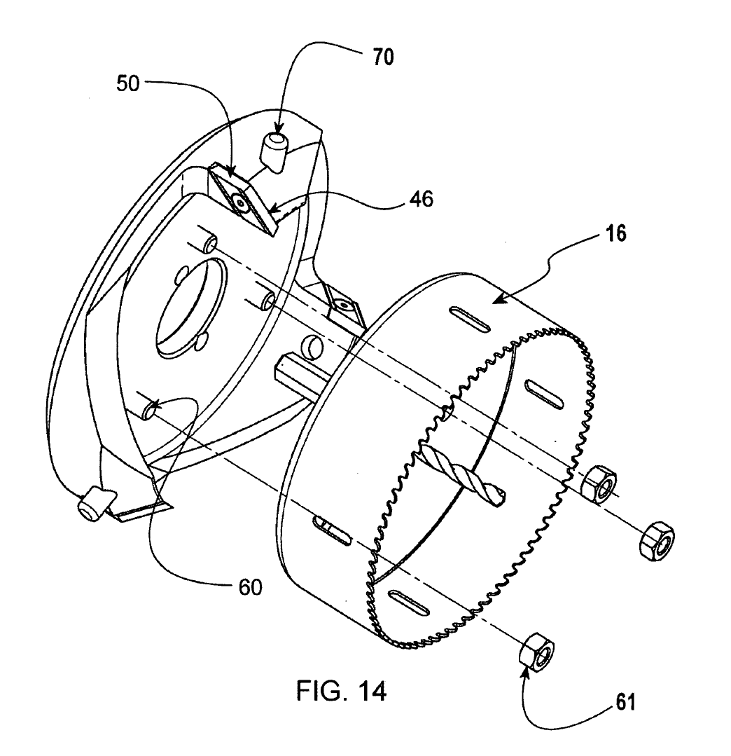

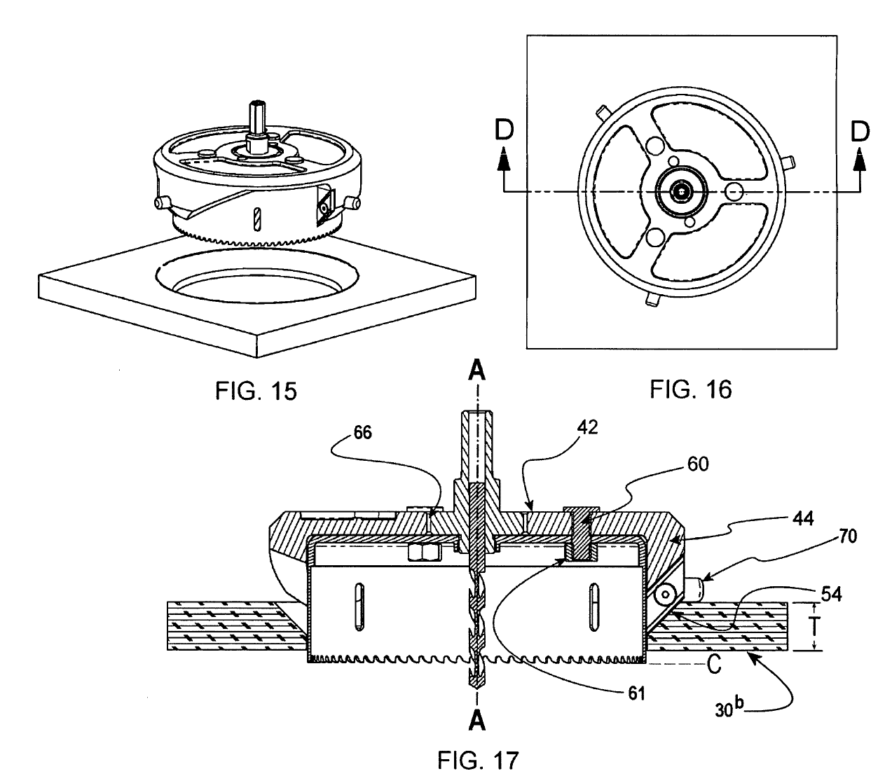

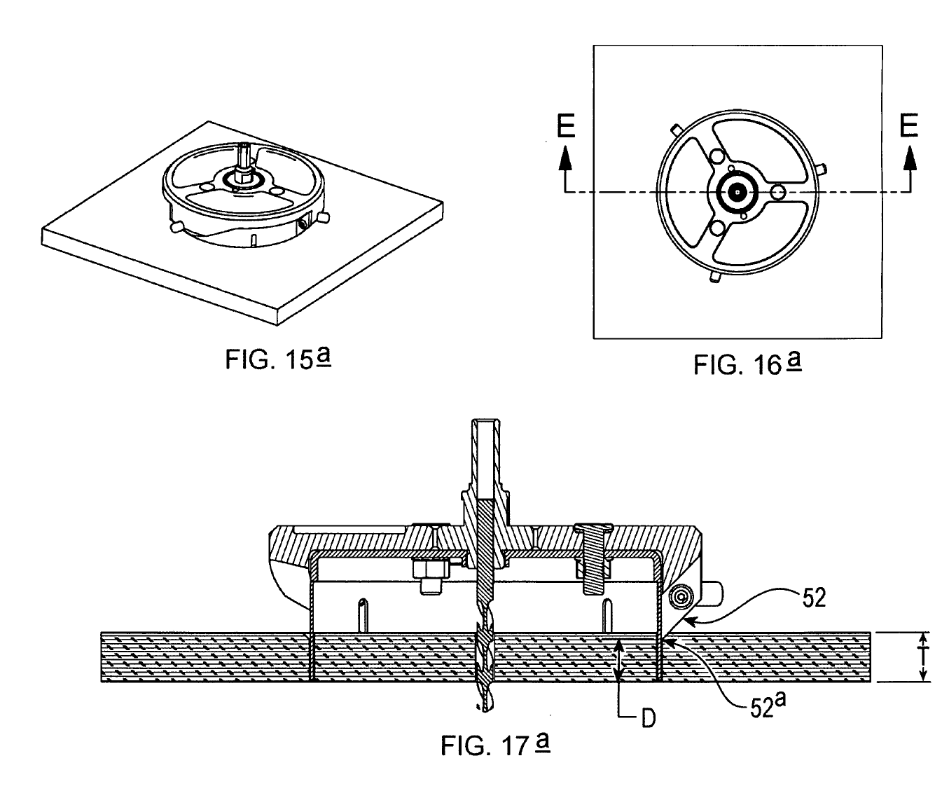

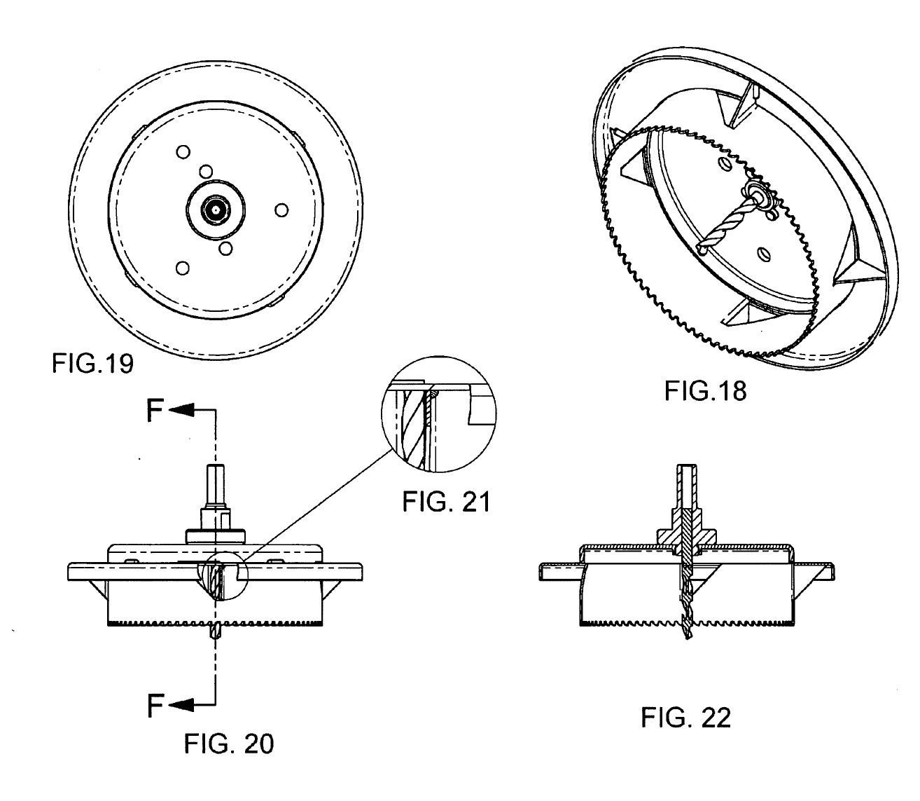

In accordance with the embodiment of the invention shown in FIGS. 11-18 inclusive, the adaptor assembly (40) is of inverted cup-like form to snugly fit over the top of the stall saw and embrace the skirt (16) in the manner shown in FIGS. 14-17. Thus the adaptor (40) has a circular top (42) having a circumferentially extending lip (44) depending from the outer peripheral edge of the top (42). Formed integrally with the lip and extending downwardly therefrom are in the present instance, three (3) arcuate generally triangularly shaped circumferentially equispaced projections (45). Each projection (45) has a pocket (46) in an axial wall (48) for mounting a cutting blade (50) wherein the cutting edge (52) is supported at an angle of about 45° to the rotational axis A¹-A¹ of the tool to form the beveled seat (54) in the subfloor as shown in FIG. 17. The cutting blade is seated by a screw fastener (56).

The tool also includes means controlling depth of the cutting stroke so that the beveled seat (54) formed during the cutting cycle is always uniform and dimensionally accurate for proper positioning of the drain assembly. Thus, the projections (45) mount three pins (70) which project radially outwardly to extend beyond the outermost edge of the tapered cutting blades (50) whereby the pins (70) engage the top surface (30a) of the subfloor (30) when the stall saw teeth (18) have cut through below the bottom surface (30b) of subfloor (30). The distance D from a plane B¹-B¹ through the lower edge of the pins (70) and a plane C-C through the cutting teeth (18) is preferably greater than the thickness T of the subfloor.

As best illustrated in FIG. 17 the adaptor (40) is secured to the top of the stall saw (10) in the present instance by three (3) circumferentially equispaced nuts and bolt fasteners (60) which engage through aligned openings in the top of the adaptor and top (14) of the stall saw (10). The top of the adaptor is also provided with plug holes (62) which align with holes (64) in the top (14) of the saw (10) to facilitate removal of the disc cut from the subfloor during the cutting operation. The top (42) of the adaptor has a circular opening (66) at its center to permit assembly and disassembly of the drill shank (24).

The lowest point (52a) of the cutting edge (52) is preferably located a predetermined axial distance D from the saw teeth (18) at the lower edge of the skirt (16) so that the saw teeth (18) have almost cut through the subfloor when the cutting edge (52) of blades (54) start to penetrate the top surface of the subfloor to form the beveled seat (54) for the drain assembly to thereby minimize drag and distribute the cutting load on the power drill. As shown in FIG. 17a, the distance D is approximately the thickness T of the subflooring. In general, this arrangement provides a smoother cutting operation.

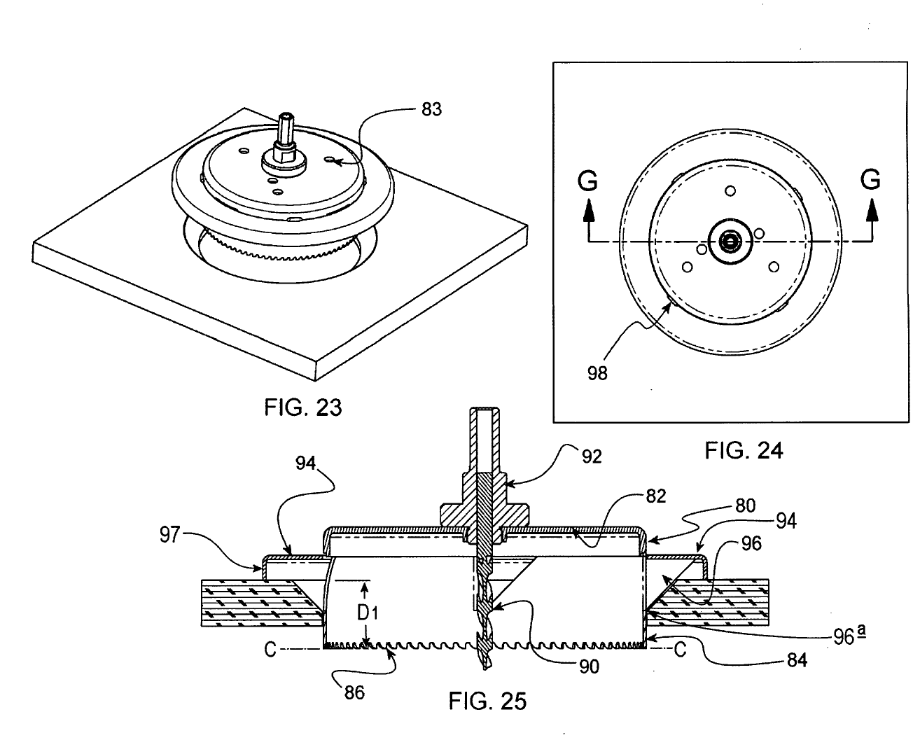

FIGS. 19-25 inclusive shown another embodiment of the present invention which like the first embodiment forms the tapered seat for a drain assembly in a single cutting operation. In this instance, the modified stall saw generally designated by the numeral (80) has a generally circular disc-like top (82), a circumferentially extending skirt (84) depending from the outer edge of the top (82) having saw teeth (86) at its lower edge.

The top (82) has several holes (83) to accommodate a tool to remove a plug of subflooring created during the seat forming process. The saw includes the usual pilot drill (90) and shank (92) which threads into adapter opening in the top at about its center.

This embodiment also includes means for limiting penetration of the saw which functions essentially the same as radial pins (70), of the first embodiment. In the present instance, the means comprises a ring-like member (94) of L-shaped cross section secured to the skirt (84) of the stall saw to engage the top surface of subfloor (30a) at the bottom of a cutting cycle as shown in FIG. 25. The limit ring (94) has a radially outwardly extending annular wall (95) secured by welding to the skirt (84) and a lip (97) depending from its outer peripheral edge spaced a predetermined axial distance (D₁) from the plane C-C of the saw teeth (86) to prevent penetration of the saw by abutting the upper face of the subfloor when the tapered seat (54) has been formed in the subfloor.

The saw has a series of tapered cutting blades (96) which in the present case are cut from the skirt (84) of the saw, bent to project radially and then spot welded as at (98) to the limit ring (94) to provide a rigid mounting of the blades. In the embodiment illustrated, there are four (4) circumferentially equispaced cutting blades (96) tapered at about an angle of 45° to the rotational axis (A¹-A¹) of the saw. The lower-most edge (96a) of the blades is spaced a predetermined axial distance D₂ from a plane C-C of the saw teeth (86) so that the angle blades (96) start cutting when the teeth (86) have almost cut through the subfloor as shown in FIG. 17a and described above.

Even though particular embodiments of the invention have been illustrated and described herein, it is not intended to limit the invention and changes and modifications may be made therein within the scope of the following claims.

What is claimed:

1. A tool for forming a tapered seat in wood subflooring for a drain fixture having a predetermined thickness comprising:
an inverted cup shaped cutting saw having a top and a depending circular skirt having saw teeth formed on the lower terminal edge of the skirt; and
an adaptor mounted on the top of said saw, at least one cutting blade mounted on said adaptor having a cutting edge disposed angularly relative to relating to the axis of rotation of said saw and detent means limiting the cutting depth of the tool to form the tapered seat in the subflooring.

2. A tool as claimed in claim 1 wherein the detent means comprises a plurality of circumferentially equispaced pins projecting radially outwardly from said skirt and spaced from said saw teeth a predetermined axial distance to function as a stop to prevent further penetration when the saw teeth have cut through the lower face of the subfloor.

3. A tool as claimed in claim 2 wherein the axial distance between a first plane through the lowest edge of the pins and a second plane through said saw teeth formed on the lower edge of the skirt is slightly greater than the predetermined thickness of the subfloor.

4. A tool for forming a beveled opening in a work piece of predetermined thickness comprising:
a cup-shaped member having a top and a skirt depending from the peripheral edge of said top having saw teeth at its lower edge;
means defining a plurality of cutting blades formed integrally with said skirt and projecting radially outwardly of the skirt and having a cutting edge angularly disposed relative to the rotational axis of the tool;
a shield projecting radially outwardly of the skirt and spaced upwardly from the saw teeth;
a predetermined axial distance slightly greater than the predetermined thickness of the work piece which abuts the top of the work piece to limit penetration when the tapered seat has been formed in the workpiece by the saw teeth and tapered cutting blades.

5. A tool for forming a tapered seat in wood subflooring for a drain fixture having a predetermined thickness comprising:
an inverted cup shaped cutting saw having a top and a depending circular skirt having saw teeth formed on the lower terminal edge of the skirt; and
an adaptor mounted on the top of said stall saw, at least one cutting blade mounted on said adaptor having a cutting edge disposed angularly to relating to the axis of rotation of said saw and detent means limiting the cutting depth of the tool to form the tapered seat in the subflooring.
